(19) United States
(12) Patent Application Publication
(10) Pub. No.: US 2018/0075576 A1
(43) Pub. Date: Mar. 15, 2018

(54) PACKING PROJECTED OMNIDIRECTIONAL VIDEOS

(71) Applicant: MEDIATEK INC., Hsin-Chu City (TW)

(72) Inventors: Shan Liu, San Jose, CA (US); Xiaozhong Xu, State College, PA (US)

(73) Assignee: MEDIATEK INC., Hsin-Chu City (TW)

(21) Appl. No.: 15/668,836

(22) Filed: Aug. 4, 2017

Related U.S. Application Data
(60) Provisional application No. 62/385,300, filed on Sep. 9, 2016.
(60) Provisional application No. 62/393,691, filed on Sep. 13, 2016.

(51) Int. Cl. G06T 3/00; H04N 13/00; G06T 3/40

(52) U.S. Cl. CPC G06T 3/0062; G06T 2207/20021; G06T 3/4038; H04N 13/0048

(57) ABSTRACT

Aspects of the disclosure provide a method for packing a two-dimensional (2D) projected image of a spherical image in an omnidirectional video sequence to form a compact image. The method can include receiving a 2D projected image generated by projecting a spherical image of an omnidirectional video onto faces of a platonic solid. The 2D projected image has regions each corresponding to a face of the platonic solid. The method can further include rearranging the regions to form a compact image. At least two nonadjacent regions in the 2D projected image corresponding to two faces that are adjacent to each other along an edge on the platonic solid are arranged to be adjacent to each other along the same edge in the compact image. As a result, continuity between the two nonadjacent regions can be maintained.

### INCORPORATION BY REFERENCE

This present disclosure claims the benefit of U.S. Provisional Application No. 62/385,300, “Methods and Apparatus for Stitching Omni-Directional Video and Image” filed on Sep. 9, 2016, and U.S. Provisional Application No. 62/393,691, “Methods and Apparatus for Stitching Omni-Directional Video and Image” filed on Sep. 13, 2016, which are incorporated herein by reference in their entirety.

### TECHNICAL FIELD

The present disclosure relates to omnidirectional video coding techniques for packing a two-dimensional (2D) projected image of a spherical image in an omnidirectional video sequence to form a compact image.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the parent disclosure.

Omnidirectional videos, also referred to as 360 degree videos, can be captured by a collection of cameras each facing in its own direction. Real world environments in all directions around the cameras can be recorded at the same time resulting in a sequence of spherical images. The captured omnidirectional videos can be viewed on a head-mounted display head with real-time head motion tracking offering an immersive visual experience to a viewer. Video compression techniques can be employed for delivery of omnidirectional videos in live streaming applications. In order to take advantage of existing video coding techniques, spherical omnidirectional images can be mapped onto a rectangular plane before input into an encoder.

### SUMMARY

Aspects of the disclosure provide a method for packing a two-dimensional projected image of a spherical image in an omnidirectional video sequence to form a compact image. The method can include receiving a 2D projected image generated by projecting a spherical image of an omnidirectional video onto faces of a platonic solid. The 2D projected image has regions each corresponding to a face of the platonic solid. The method can further include rearranging the regions to form a compact image. At least two nonadjacent regions in the 2D projected image corresponding to two faces that are adjacent to each other along a first edge on the platonic solid are at arranged to be adjacent to each other along the same first edge in the compact image. As a result, continuity between the two nonadjacent regions can he maintained.

The compact image can be rectangular. In addition, rearranging the regions can be performed in a manner such that a number of discontinuous boundaries in the compact image can be less than a number of discontinuous boundaries in the 2D projected image. In one example, the platonic solid is one of an octahedron or an icosahedron.

In an embodiment, rearranging the regions include rotating a first region of the two nonadjacent regions, such that the rotated first region is connected with a second region of the two nonadjacent regions along the first edge. In one example, rearranging the regions further include rotating a third region, such that the rotated third region is connected with the second region along a second edge to form a connected region including the first, second and third regions. Two faces on the platonic solid corresponding to the second and third regions are adjacent to each other along the same second edge.

In an embodiment, rearranging the regions include adjusting the two nonadjacent regions along the same first edge to form a connected region, and moving the connected region to fill a blank area in the 2D projected image.

Aspects of the disclosure provide a video system including circuitry. The circuitry is configured to receive a two-dimensional (2D) projected image generated by projecting a spherical image of an omnidirectional video onto faces of a platonic solid. The 2D projected image has regions each corresponding to a face of the platonic solid. The circuitry is further configured to rearrange the regions to form a compact image. At least two nonadjacent regions in the 2D projected image corresponding to two faces that are adjacent to each other along a first edge on the platonic solid are arranged to be adjacent to each other along the same first edge in the compact image.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a 360 degree video system according to an embodiment of the disclosure;

FIGS. 2A-2E show examples of 2D projected images according to an embodiment of the disclosure;

FIG. 3 shows a rectangular image including an icosahedral projected image;

FIGS. 4A-4C show examples of straightforward packing methods according to and embodiment of the disclosure;

FIGS. 5-8 show example packing methods for packing an icosahedral projected image according to embodiments of the disclosure;

FIGS. 9-15 show example packing methods for packing an octahedral projected image according to embodiments of the disclosure; and

FIG. 16 shows a process for packing regions in a 2D projected image to form a rectangular compact image according to an embodiment of the disclosure.

### DETAILED DESCRIPTION OF EMBODIMENTS

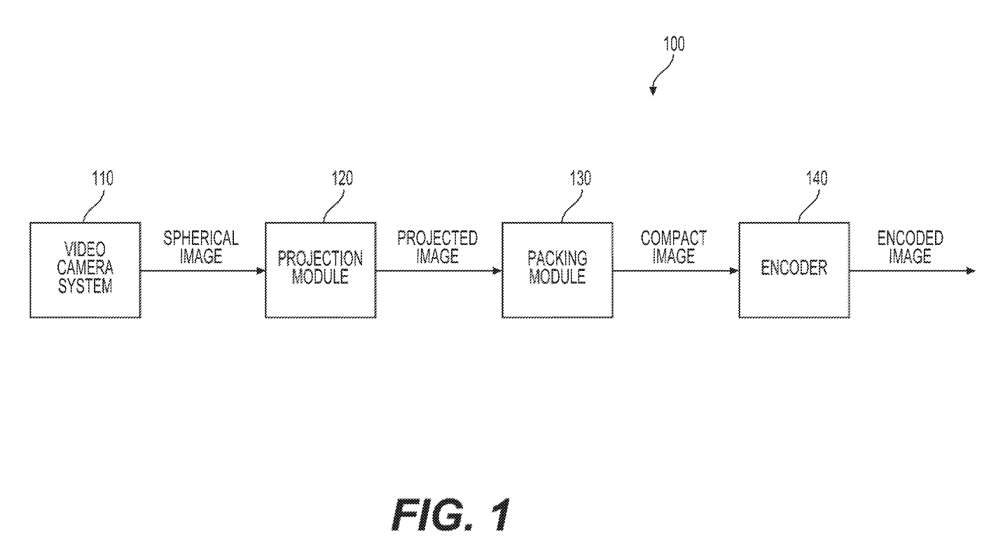

FIG. 1 shows a 360 degree video system 100 according to an embodiment of the disclosure. The video system 100 can include a video camera system 110, a projection module 120, a packing module 130, and an encoder 140. The video system 100 can capture a 360 degree video, encode the captured video, and transmit the encoded video to a remote video system. At the remote video system, a reverse process may be performed to render the 360 degree video, for example, to a display device, such as a head-mounted display.

The video camera system 110 is configured to capture a 360 degree video. In one example, the video camera system 110 includes multiple cameras facing in different directions. Views in all directions around the video camera system 100 can be recorded at the same time. Images captured at each camera at a time can be combined together by performing a stitching process. The combined image can be based on a spherical model, thus forming a spherical image. For example, pixels or samples of the spherical image can be positioned on a spherical surface. Coordinates of a three-dimensional (3D) coordinate system can be employed to indicate a position of a pixel. A sequence of such spherical images forms the 360 degree video which is provided to the projection module 120.

The projection module 120 is configured to map a received spherical image to a two-dimensional (2D) plane resulting in a 2D image. The mapping can be realized by performing a projection, such as a platonic solid projection. In a platonic solid projection, a spherical image is projected to faces of a platonic solid that encloses a sphere to which the spherical image is attached. The platonic solid projection can be one of a tetrahedral projection, a cubic projection, an octahedral projection (OHP), a dodecahedral projection, or an icosahedron projection (ISP).

A projection operation on a spherical image results in a projected image of a certain projection format on a 2D plane. For example, an octahedral projection performed on a spherical image results in a projected image on a 2D plane, and the 2D projected image is in an octahedral projection format (also referred to as an octahedral format). Similarly, an icosahedral projection results in a projected image of an icosahedral projection format (also referred to as icosahedral format). A platonic solid projection format can have different layouts depending on arrangement of platonic solid faces in the respective projected image. The 2D projected image generated at the projection module 120 is subsequently provided to the packing module 130.

The packing module 130 receives the 2D projected image and performs a packing process to rearrange regions in the projected image to form a compact image. The 2D projected image can result from a projection on a platonic solid, and accordingly each region in the 2D projected image corresponds to a face of the platonic solid. The 2D projected image can have a layout in a which different regions are separate from each other and blank areas exist among the regions. The packing module 130 can pack the regions in the 2D projected image into the compact image thus transforming the projected image into the compact image having a more compact format. For example, the compact image can have a rectangular shape, and blank areas can be reduced or eliminated in the compact image. If the projected image is directly fed to the encoder 140 without the packing process, samples filled in the blank areas can lead to a larger buffer size in the encoder 140 and a higher bit rate for delivery of the projected image in contrast to feeding to the encoder 140 the compact image winch contains no blank area. Thus. the packing process can save storage and bandwidth for the coding process at the encoder 140.

In addition, according to an aspect of the disclosure, the packing module 130 can optionally reduce discontinuities in the compact image. A discontinuity in the compact image takes place at a boundary of two neighboring regions which correspond to two faces that are nonadjacent along the boundary on the corresponding platonic solid. Discontinuities in the compact image may reduce coding efficiency and quality. Transformation of a protected image to a compact image with minimized boundary discontinuities can thus impure coding efficiency of the coding process at the encoder 140.

The encoder 140 receives compact images from the packing module 130 and encodes the received compact images to generate a bit stream carrying encoded 360 degree video data. The encoder 140 can employ various video compression techniques to encode the received compact images in a rectangular shape. The encoder 140 can be compliant with an existing video coding standard, such as the High Efficiency Video Coding (HEVC) standard, the Advanced Video Coding (AVC) coding standard, and the like. The resultant bit stream can subsequently be transmitted to a remote device where the encoded 360 degree video can be decoded and rendered to a display device. Alternatively, the resultant bit stream can be provided and stored to a storage device.

In various examples, the components 120-140 of the video system 100 can be implemented with hardware, software, or combination thereof. In one example, the packing module 130 is implemented with one or more integrated circuits (ICs), such as an application specific integrated circuit (ASIC), field programmable gate array (FPGA), and the like. In another example, the packing module 130 is implemented as software or firmware including instructions stored in a computer-readable non-volatile storage medium. The instructions, when executed by a processing circuit, causing the processing circuit to perform functions of the packing module 130. The computer-readable non-volatile storage medium and the processing circuit can be included in the video system 100.

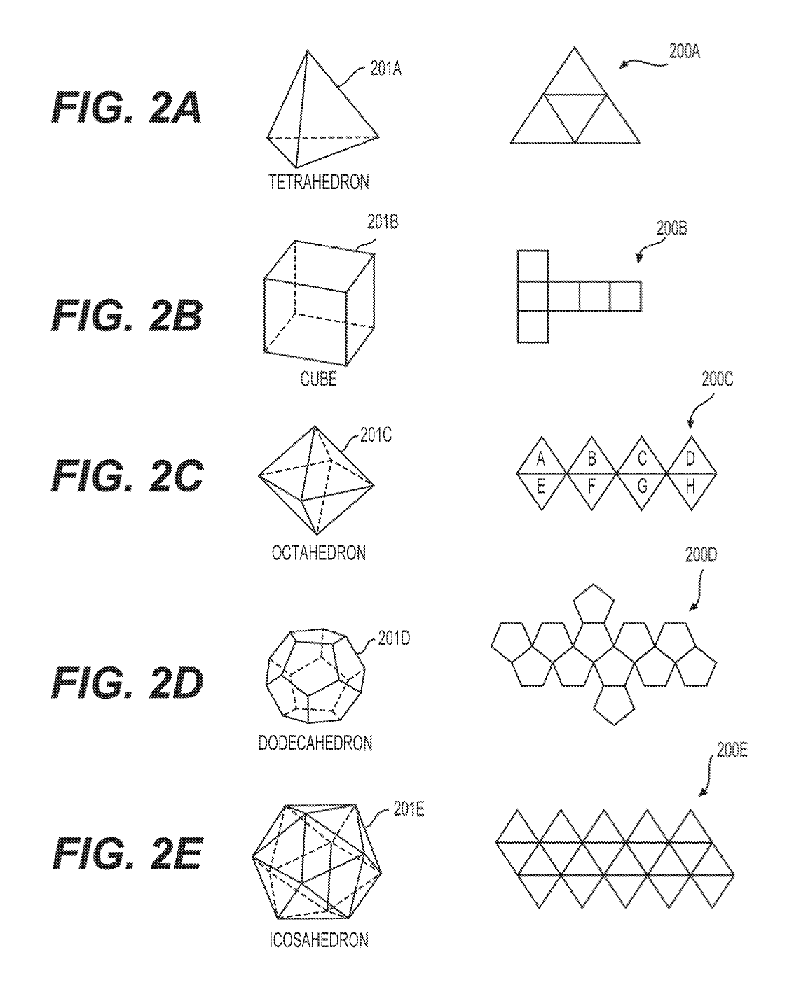

FIGS. 2A-2E show examples of 2D projected images 200A-200E, respectively, according to an embodiment of the disclosure. The projected images 200A-200E are obtained by performing one of the following projection types: a tetrahedral projection, a cubic projection, an octahedral projection, a dodecahedral projection, and an icosahedral projection. Accordingly, the projected images 200A-200E are of a tetrahedral format, a cubic format, an octahedral format, a dodecahedral format, and an icosahedral format, respectively. To the left of each of the projected images 200A-200E, a platonic solid is shown indicating the type of the projection resulting in the respective projected image. Each projected image 200A-200E can include multiple regions. Each region corresponds to a face of the respective platonic solid. For example, the octahedral projection image 200C in FIG. 2C includes eight regions A-H each corresponding to one of the eight faces of the octahedron solid 201C.

It is noted that projected images corresponding to a certain projection format can have different layouts. In alternative examples, layouts of projected images can be different from what are shown in FIGS. 2A-2F. For example, samples on each face of a platonic solid can first be calculated during a projection process. Then, the faces of the platonic solid can be unfolded onto a 2D plane such that the samples on each face can be mapped to a 2D plane. The faces can he arranged in various ways on the 2D plane during the unfolding process resulting in various layouts of 2D projected images.

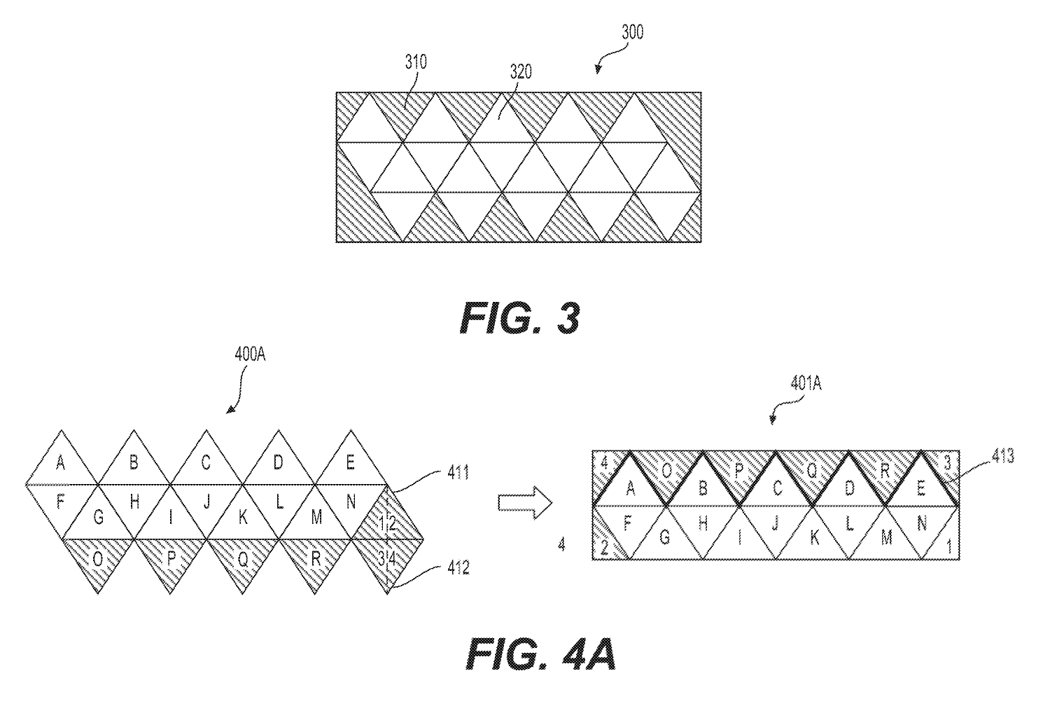

FIG. 3 shows a rectangular image 300 including an icosahedral projected image 320. The icosahedral projected image 320 can result from an icosahedral protection, for example, performed at the projection module 120 in FIG. 1 example. Assuming the projected image 320 is going to be feed to the encoder 140 without a packing process, the rectangular process icosahedral projected image 320 inside the rectangular image 300 includes twenty triangular regions filled with video sample. The rectangular image 300 also includes blank area 310 (shaded areas in FIG. 3). Blank areas in a 2D rectangular image including a projected image of a platonic projection format refer to areas in the rectangular usage excluding areas within the projected image. The blank areas 310 do not contain useful video data, and can be filled with samples having default values. When feeding the rectangular image 300 to a video encoding process, the blank areas consume additional storage spaces and waste bit rate.

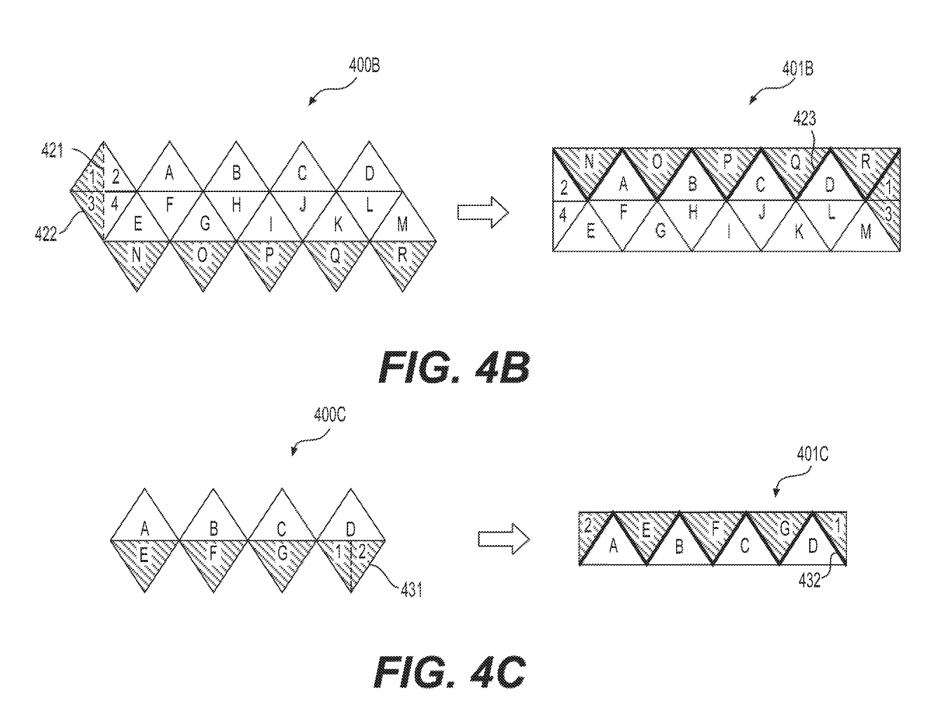

FIGS. 4A-4C show examples of straightforward packing methods according to an embodiment of the disclosure. The straightforward packing methods can be employed to transform a projected image in a platonic solid projection format to a compact representation. Specifically, in FIG. 4A, a projected image 400A in the icosahedral format is shown at the left side, and a compact image 401A resulting from a packing process is shown at the right side. The projected image 400A has a layout as shown in FIG. 4A, and includes twenty regions A-R and 411-412. Each region (i.e. A-R and 411-412) has a shape of an equilateral triangle. During the packing process, the regions O-R in the bottom row of the icosahedral projected image 400A are moved upward to fill blank areas among the regions A-E. The regions 411-412 a the bottom right corner are split into four sub-regions 1-4. The sub-regions 2-4 are disposed to the bottom left, top right and top left corners of the compact image 401A.

As shown, the resultant compact image 401A has a rectangular shape and does not include any blank areas. However, discontinuity exists along boundaries 413 (thick solid lines In FIG. 4A) between regions A-E and the translates regions O-R and 1-3. Discontinuity takes place along a boundary in a compact image resulting from a packing process when two regions, which are not adjacent to each other along the boundary on surface of the respective platonic solid, are arranged to be adjacent to each other along the boundary. A boundary, across which two adjacent areas are not continuous, is referred to as a discontinuous boundary. In contrast, continuity exists across a boundary in a compact image when two regions, which are adjacent to each other along the same boundary on surface of the respective platonic solid, are arranged to be adjacent to each other along the boundary. According to the disclosure, more discontinuities along region boundaries in a compact image lead to higher bit rate encoding the compact image. Thus, discontinuities along discontinuous boundaries should be reduced during the respective packing process.

FIG. 4B shows an icosahedral projected image 400B at the left side and a compact image 401B at the right side. A packing process is performed to transform the projected image 400B into the compact image 401B. The projected image 400B including twenty regions A-R and 421-422. During the packing process, the regions N-R at the bottom of the projected image 400B are translated upward to fill blank areas among the regions A-D and 421. In addition, the regions 421-422 are split into four sub-regions 1-4, and the sub-regions 1 and 3 are translated to fill blank areas at the right end of the compact image 401B. The compact image 401B resulting from the packing process includes no blank areas. However, the compact image 401B includes ten discontinuous boundaries 423 (indicated by thick solid lines) between the regions N-R and regions A-D and 1-2.

FIG. 4C shows an octahedral projected image 400C at the left side and a compact image 401C at the right side. A packing process is performed to transform the projected image 400C into the compact image 401C. The projected image 400C including eight regions A-G and 431. During the packing process, the regions E-G in the bottom row of the projected image 400C are translated right upward to fill blank areas among the regions A-D. In addition, the regions 431 is split into two sub-regions 1-2, and the sub-regions 1 and 2 are translated to fill blank areas at the top left and top right corners of the compact image 401C. The compact image 401C resulting from the packing process includes no blank areas. However, the compact image 401C includes eight discontinuous boundaries 432 (indicated by thick solid lines) between the regions A-D and regions E-G and 1-2.

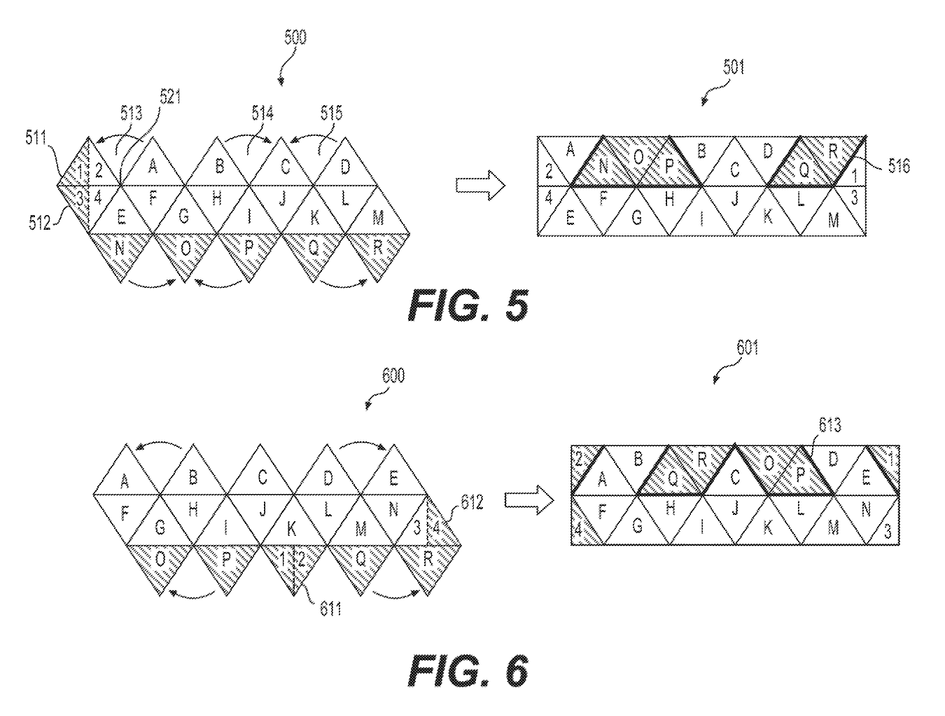

FIG. 5 shows an example of a packing method according to an embodiment of the disclosure. An icosahedral projected image 500 is shown at the left side of the FIG. 5, and a rectangular compact image 501 is shown at the right side. The projected image 500 results from an icosahedral projection where a spherical image is projected to faces of an icosahedron. The projected image 500 includes twenty regions A-R and 511-512 disposed in three rows forming a layout as shown in FIG. 5. Each region has an equilateral triangle shape. Particularly, the projected image 500 is continuous across each boundary between the regions in the projected image 500. However, the neighboring regions 511 and A-D, which form a continuous region when combined together on the surface of the icosahedron for the icosahedral projection, are separated from each other in the layout, and share no common boundaries. Similarly, the neighboring regions N-R form a continuous region when combined on the surface of the icosahedron but share no common boundaries in the projected image 500.

The regions A-R and 511-512 can be rearranged to form the compact image 501 by performing a packing process. The packing process can include the following steps. At a first step, one or more regions of the projected image 500 are rotated with respect to respective circumcenters and merged or connected with a respective neighboring region. Alternatively, in some examples, one or more regions of the projected image 500 are rotated with respect to a vertex shared with a respective neighboring region until becoming merged or connected with the respective neighboring region. As a result, one or more merged or connected regions can be formed. Each merged or connected region cast include an image area winch is continuous across one or more boundaries inside the respective merged region. Accordingly, continuity is preserved in each merged region during the packing process. In some examples, the merged regions can have a shape of a parallelogram, trapezoid and the like.

For example, the region A in the top row is rotated anti-clockwise by 60 degrees with respect to the circumcenter of the region A, and then merged or connected with the neighboring region 511. As a result, a blank area 513 is filled by the rotated region A, and a parallelogram including the regions A and 511 is formed. Faces corresponding to the regions A and 511 on the platonic solid for generation of the 2D projected image 500 are adjacent to each other along an edge. After the rotation and merging operation, the regions A and 511 are now adjacent to each other along the same edge. Accordingly, the parallelogram is continuous across the edge. Alternatively, in one example, the region A is rotated anti-clockwise by 60 degrees with respect to a vertex 521. As a result, the region A is merged or connected with the neighboring region 511. In the above two examples, the operation performed in the first example (rotating with respect to a circumcenter and subsequent merging with a neighboring region) has the same effect as the operation performed in the second example (rotating with respect to a vertex shared with a neighboring region until becoming merged or connected).

The region B in the top row is rotated clockwise by 60 degrees and merged with neighboring region C from the left side, and the region D in the top row is rotated anti-clock wise by 60 degrees and merged with the neighboring region C from the right side. As a result, the blank areas 514 and 515 are filled by the rotated regions B and D respectively, and a trapezoid including the regions B-D is formed. Similarly, the regions N and P next to the region O in the bottom row can be rotated and merged with the region O to form a trapezoid including the regions N-P, and the region Q in the bottom row can be rotated and merged with the neighboring region R to form a parallelogram. Image areas within each of the above merged regions (the parallelogram of the regions 511 and A, the trapezoid of the regions B-D, the parallelogram of the regions Q-R, and the trapezoid of the regions N-P) are continuous across boundaries inside each merged region. Accordingly, continuity is preserved within each merged region.

At a second step, part of the merged regions is translated to fill blank areas within the projected image 500. For example, after the rotation and combination (merging) operations in step one, some blank areas are formed in the top row of the projected image 500. Accordingly, the trapezoid of the regions N-P and the parallelogram of regions Q-R can be translated upward to fill the blank areas in the top row as shown in the compact image 501. Additionally, the regions 511 and 512 can be split into sub-regions 1-4. The sub-regions 1 and 3 can be translated to fill a blank area at the right end of the projected image 501. In some embodiments, operations regarding the sub-regions 1-4 (i.e., the regions 511 and 512 are split into sub-regions 1-4, and the sub-regions 1 and 3 are translated to fill a blank area at the right end of the projected image 501) can be performed before or simultaneously with the first step (i.e., one or more regions of the projected image 500 are rotated and merged with a respective neighboring region. Accordingly, the compact image 501 can be obtained.

The compact image 501 resulting from the above packing process has a rectangular shape, which conforms to the input image format of a typical video codec implementing existing video coding standards. In addition, the compact image 501 does not include blank areas. Further, the compact image 501 includes seven discontinuous boundaries 516 which are fewer than the ten discontinuous boundaries of the compact image 401A in the FIG. 4A example.

It is noted that packing operations performed on a region in a projected image during a packing process, such as rotation, merging, moving, shifting, and the like, can be understood to be changing positions of samples included in the respective region on a 2D plane. For example, positions of samples in the region can be represented by coordinates of a certain coordinate system. When performing a packing operation, new coordinates of samples corresponding to a new location resulting from the packing operation can be accordingly calculated to represent new positions of the samples.

FIG. 6 shows an example of a packing method according to an embodiment of the disclosure. An icosahedral projected image 600 is shown at the left side, and a rectangular compact image 601 is shown at the right side. The icosahedral projected image 600 is similar to the projected image 500 in FIG. 5, and includes twenty regions A-R and 611-612. A packing process similar to that performed in the FIG. 5 example can be performed to rearrange the regions A-R and 611-612. As shown, at a first step, the regions B, D, P, Q are rotated by 60 degrees either clockwise or anti-clock wise and then merged with a nearby region to form four parallelograms. At a second step, the merged regions (the parallelogram including the regions O-P and the parallelogram including the regions Q-R are translated upward to fill blank areas in the top row. Subsequently. the regions 611-612 are split into four sub-regions 1-4. The sub-regions 1-2 and 4 are moved to fill three corner blank areas. The resultant compact image 601 includes eight discontinuous boundaries 613 indicated by thick solid lines.

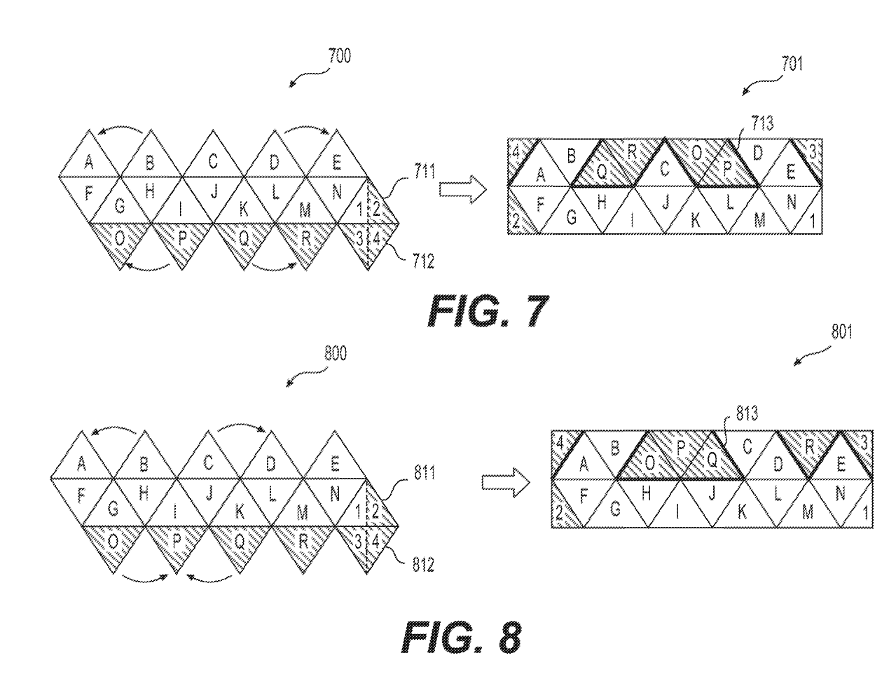

FIG. 7 shows an example of a packing method according to an embodiment of the disclosure. An icosahedral projected image 700 is shown at the left side, and a rectangular compact image 701 is shown at the right side. The icosahedral projected image 700 is similar to the projected image 500 in FIG. 5, and includes twenty regions A-R and 711-712. A packing process similar to that performed in the FIG. 5 example can be performed to rearrange the regions A-R and 711-712. As shown, at a first step, the regions B, D, P, Q are rotated by 60 degrees either clockwise or anti-clock wise and then merged with a nearby region to form four parallelograms. At a second step, the merged regions (the parallelogram including the regions O-P and the parallelogram including the regions Q-R are translated upward to fill blank areas in the top row. Additionally, the regions 711-712 are split into four sub-regions 1-4. The sub-regions 2-4 are moved to fill three corner blank areas. The resultant compact image 701 includes eight discontinuous boundaries 713 indicated by thick solid lines.

FIG. 8 shows an example of a packing method according to an embodiment of the disclosure. An icosahedral projected image 800 is shown at the left side, and a rectangular compact image 801 is shown at the right side. The icosahedral projected image 800 is similar to the projected image 500 in FIG. 5, and includes twenty regions A-R and 811-812. A packing process similar to that performed in the FIG. 5 example can be performed to rearrange the regions A-R and 811-812. As shown, at a first step, the regions B-C in the top row are rotated by 60 degrees anti-clock wise or clockwise, respectively, and then merged with a nearby region to form two parallelograms. The regions O and Q are rotated by 60 degrees clockwise or anti-clockwise respectively, and merged with the neighboring region P to form a trapezoid. At a second step, the trapezoid is translated upward to fill blank areas between the rotated regions B and C in the top row. The region R is translated upward to fill a blank area between the regions D and E. Additionally, the regions 811-812 are split into fours sub-regions 1-4. The sub-regions 2-4 are moved to fill three corner blank areas. The resultant compact image 801 includes eight discontinuous boundaries 813 indicated by thick solid lines.

In various embodiments, other packing methods similar to the examples shown in FIGS. 5-8 can be derived based on top to bottom symmetry or left to right symmetry of an icosahedral projection image. For example, different triangular regions in the top row or bottom row can be selected to be rotated and merged in the first step. Regions in the top row, either a merged region or an original region, can be moved to fill blank areas in the bottom row after the bottom row has been processed (rotated, merged, or moved away). In addition, a target rectangular compact image can have a width and height different from the FIGS. 5-8 examples.

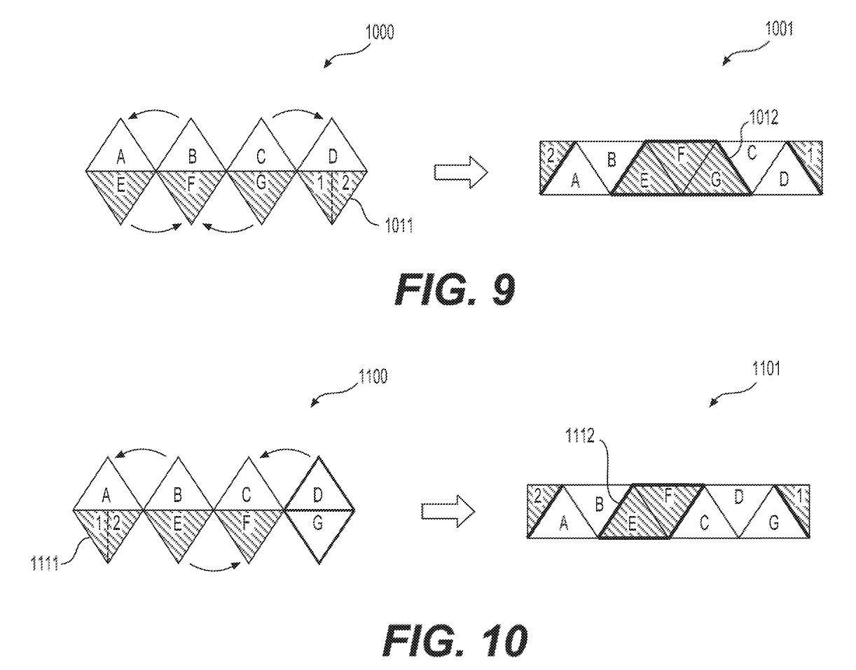

FIG. 9 shows an example of a packing method according to an embodiment of the disclosure. A projected image 1000 in octahedral format is shown at the left side of the FIG. 9, and a rectangular compact image 1001 is shown at the right side. The projected image 1000 results from an octahedral projection where a spherical image is projected to eight faces of an octahedron. The projected image 100 includes eight regions A-G and 1011 disposed in two rows forming a layout as shown in FIG. 9. Each region has an equilateral triangle shape. Particularly, the projected image 1000 is continuous across each boundary within each of four pairs of regions: A and E, B and F, C and G, D and 1011. However, the neighboring regions A-D, which form a continuous region when combined together on the surface of the octahedron for the octahedral projection, are separated from each other in the layout, and share no common boundaries. Similarly, the neighboring regions E-G and 1011 form a continuous region when combined on the surface of the octahedron but share no common boundaries in the projected image 1000.

The regions A-G and 1011 can be rearranged to form the compact image 1001 by performing the packing process. The packing process can include the following steps. At a first step, one or more regions of the projected image 1000 are rotated and merged with a respective neighboring region. As a result, one or more merged regions can be formed. Each merged region can include an image area which is continuous across one or more boundaries inside the respective merged region. Accordingly, continuity is preserved within merged regions during the packing process. In some examples the merged regions can have a shape of a parallelogram, trapezoid, and the like.

For example, the region B in the top row is rotated anti-clockwise by 60 degree, and then merged with the neighboring region A. As a result, a parallelogram including the regions A and B is formed. The region C in the top row is rotated clockwise by 60 degrees and merged with the region D. As a result, a parallelogram including the regions C-D is formed. Similarly, the region E in the bottom row can be rotated anti-clock wise by 60 degrees and merged with the region F from the left side, while the region G in the bottom row can be rotated clockwise by 60 degrees and merged with the region F from the right side. As a result, a trapezoid including the regions E-G can be formed. Image areas within each of the above merged regions (the parallelogram of the regions A and B, the parallelogram of the regions C and D, the trapezoid of the regions E-G) are continuous across boundaries inside each merged region. Accordingly, continuity is preserved within each merged region.

At a second step, part of the merged regions is translated to fill blank areas within the projected image 1000. For example, after the rotation and combination (merging) operations in step one, a blank area is formed in the top row of the projected image 1000. Accordingly, the trapezoid of the regions E-G can be translated upward to fill the blank area in the top row as shown in the compact image 1001. Additionally, the region 1101 can be split into sub-regions 1-2. The sub-regions 1-2 can be translated to fill two blank areas at the top left and top right corner of the compact image 1001. Accordingly, the compact image 1001 can be obtained.

The compact image 1001 resulting from the above packing process has a rectangular shape, which conforms to the input image format to a typical video codec implementing existing video coding standards. In addition, the compact image 1001 does not include blank areas. Further, the compact image 1001 includes four discontinuous boundaries 1017 which are fewer than the eight discontinuous boundaries of the compact image 401C in the FIG. 4C example.

FIG. 10 shows an example of a packing method according to an embodiment of the disclosure. An octahedral projected image 1100 is shown at the left side, and a rectangular compact image 1101 is shown at the right side. The octahedral projected image 1100 is similar to the projected image 1000 in FIG. 9, and includes eight regions A-G and 111. A packing process similar to that performed in the FIG. 9 example can be performed to rearrange the regions A-G and 1111. As shown, at a first step, the regions B, E, D, G are rotated by 60 degrees either clockwise or anti-clockwise and then merged with a nearby region. Specifically, a first parallelogram including the regions A and B, and a second parallelogram including the regions E and F are formed. The rotated regions D and G are merged with the thereby region C forming a trapezoid. At a second step, the merged region, the parallelogram including the regions E-F, is translated upward to fill a blank area in the top row. Additionally, the region 1111 is split into sub-regions 1-2 which are moved to fill two corner blank areas. The resultant compact image 1101 includes four discontinuous boundaries 1112 indicated by thick solid lines.

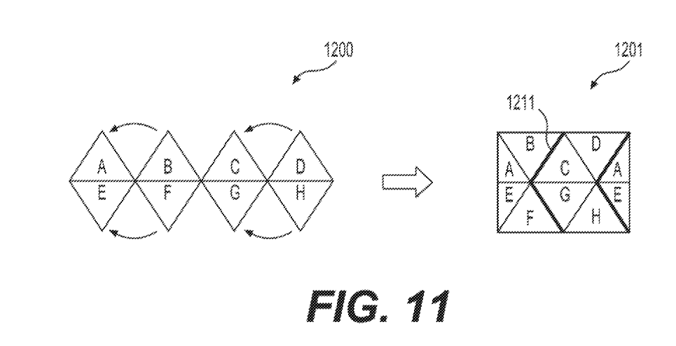

FIG. 11 shows example of a packing method according to an embodiment of the disclosure. An octahedral projected image 1200 is shown at the left side, and a rectangular compact image 1201 is shown at the right side. The octahedral projected image 1200 is similar to the projected image 1000 in FIG. 9, and includes eight regions A-H. A packing process similar to that performed in the FIG. 9 example can be performed to rearrange the regions A-H. Specifically, at a first step, the regions B, F, D, H can be rotated by 60 degrees either clockwise or anti-clockwise and then merged with a nearby region, thereby forming four parallelograms corresponding to four pairs of regions: A and B, E and F, C and D, G and H. At a second step, the two right-hand merged regions are translated leftward and merged with the two left-hand merged regions. Additionally, the regions A and E are split and the left side split is moved to fill a blank area at the right end of the compact image 1201. The resultant compact image 1201 includes four discontinuous boundaries 1211 indicated by thick solid lines.

FIG. 15 shows an example of a packing method according to an embodiment of the disclosure. An octahedral projected image 1300 is shown at the left side, and a rectangular compact image 1301 is shown at the right side. The octahedral projected image 1300 is similar to the projected image 1000 in FIG. 9, and includes eight regions A-H. A packing process similar to that performed in the FIG. 9 example can be performed to rearrange the regions A-H. Specifically, at the first step, the regions A and C at the top row can be rotated by 60 degrees clockwise or anti-clockwise, respectively, and then merged with the nearby region B, thereby forming a trapezoid. Similarly, the regions E and G can be rotated and then merged with the region F to form another trapezoid. At a second step, the two regions D and H are translated leftward and combined with the two trapezoids. Additionally, the regions D and H are split and the right side split is moved to fill a blank area at the left end of the compact image 1301. The resultant compact image 1301 includes four discontinuous boundaries 1311 indicated by thick solid lines.

In various embodiments, other packing methods similar to the examples shown in FIGS. 10-13 can be derived based on top to bottom symmetry or left to right symmetry of an octahedral projection image. For example, different triangular regions in the top row or bottom row can be selected to be rotated and merged in the first step. Regions in the top row, either a merged region or an original region, can be moved to fill blank areas in the bottom row after the bottom row has been processed (rotated, merged, or moved away). h In addition a target rectangular compact image can have a width and height different from the FIGS. 10-13 examples.

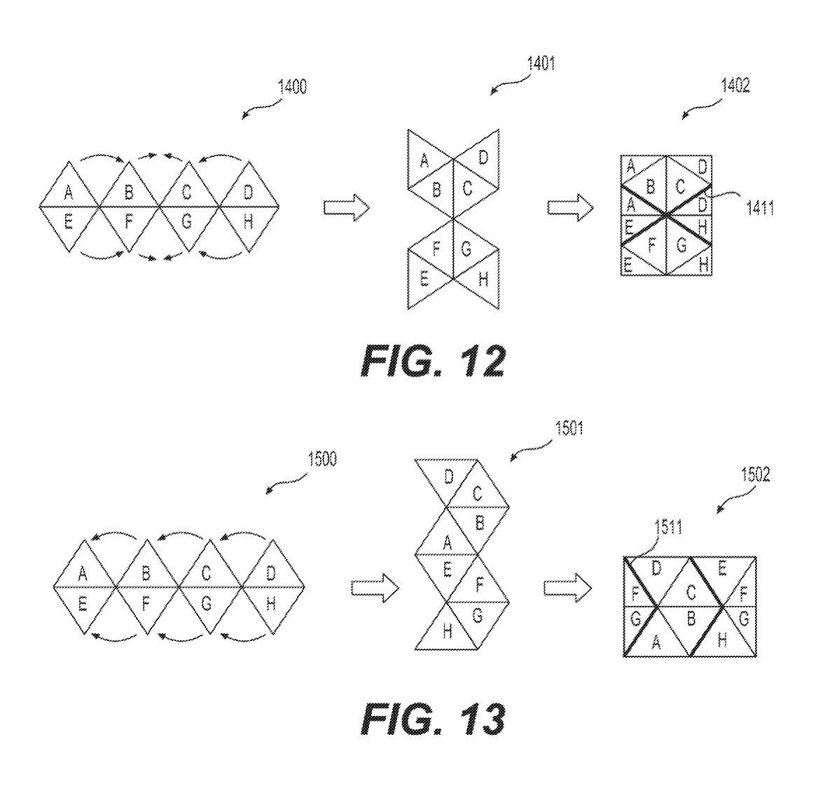

Fig 1 shows an example of a packing method according to an embodiment of the disclosure. An octahedral projected image 1400, an intermediate image 1401, and a rectangular compact image 1402 are shown in FIG. 12. The octahedral projected image 1100 is similar to the protected image 1000 in FIG. 9, and includes eight regions A-H. A packing process can be performed to rearrange the regions A-H to obtain the compact image 1402. Specifically, at a first step, the regions A-D at the top row can be rotated, and then combined together to form an upper half of the intermediate image 1401 as shown. Similarly, the regions E-H can be rotated and combined to form a lower half of the intermediate image 1401. At a second step, the regions A, D, E, H are split and the resultant splits can be moved to fill blank areas at the middle of the compact image 1402. The resultant compact image 1402 includes four discontinuous boundaries 1411 indicated by thick solid lines.

FIG. 13 shows an example of a packing method according to an embodiment of the disclosure. An octahedral projected image 1500, an intermediate image 1501, and a rectangular compact image 1502 are shown in FIG. 13. The octahedral projected image 1500 is similar to the projected image 1000 in FIG. 9, and includes eight regions A-H. A packing process can be performed to rearrange the regions A-H to obtain the compact image 1502. Specifically, at a first step, the regions B-D at the top row can be rotated clockwise by 60, 120, and 180 degree, respectively, and then combined together with the region A to form an upper half of the intermediate image 1501. Similarly, the regions E-H can be rotated anti-clockwise by 60, 120, and 180 degree, respectively, and combined with the region E to form a lower half of the intermediate image 1501. At a second step, the lower part merged region in the intermedia image 1501 can be moved to combine with the upper part merged region in the intermedia image 1501. Additionally, the regions F and G can be split and half of the resultant splits can be moved to fill blank areas at the left side of the compact image 1502. The resultant compact image 1502 includes four discontinuous boundaries 1511 indicated by thick solid lines.

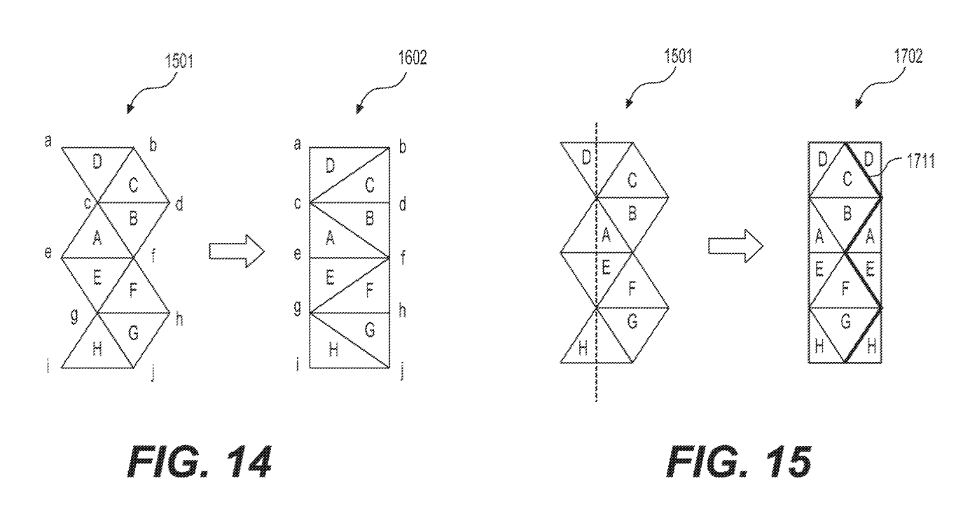

FIG. 14 shows an examples of a packing method according to an embodiment of the disclosure. The intermediate image 1501 in FIG. 13 is shown at the left side. A compact image 1602 is shown at the right side. In a packing method, rotation and merging operations similar to that of FIG. 13 example can first be performed to obtain the intermediate image 1501. Subsequently, each region in the intermediate image 1501 can be stretched to form the rectangular compact image 1602. Edges and vertices a-j of the intermediate image 1501 are mapped into corresponding positions in the compact image 1602.

FIG. 15 shows an example of a packing method according to an embodiment of the disclosure. The intermediate image 1501 in FIG. 13 is shown at the left side. A compact image 1702 is shown at the right side. In a packing method, rotation and merging operations similar to that of FIG. 13 example can first be performed to obtain the intermediate image 1501. Subsequently, the regions D, A, E, H can be split. A half of the resultant splits can be moved rightward to fill blank areas at the right side of the compact image 1702. The resultant compact image 1702 includes four discontinuous boundaries 1711.

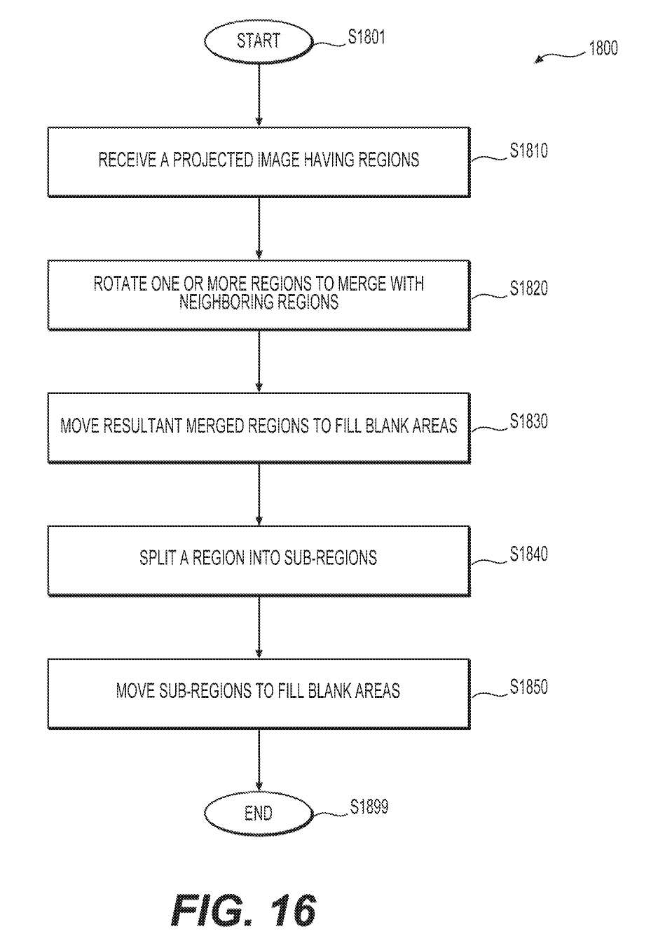

FIG. 16 shows a process 1800 for packing regions in a 2D projected image to form a rectangular compact image according to an embodiment of the disclosure. The process 1800 can be performed at the packing module 130 in FIG. 1 example. The process 1800 starts at S1801, and proceeds to S1810.

At S1810, a 2D projected image is received. The projected image can result from a platonic solid projection in which a spherical image is projected to laces of a platonic solid. Unfolding the platonic solid results in the 2D projected image. The platonic solid can be concentric with the spherical image. The projected image can include multiple regions each corresponding to a face of the respective platonic solid. The projected image in a certain platonic solid projection format can have different layout on a 2D plane.

At S1820, one or more regions of the projected image are rotated to merge with respective neighboring regions in the projected image to form merged or connected regions. For example, the rotation can be performed clockwise or anti-clockwise by 60, 120, or 180 degrees. In a first approach, the rotation is performed with respect to a circumcenter of a region, and subsequently the rotated region is merged or connected with a neighboring region. In a second approach, the rotation is performed with respect to a vertex shared between two neighboring regions resulting in the two neighboring regions being merged or connected with each other. An image of each merged region is continuous across one or more boundaries within the merged region, thereby preserving continuity within the merged region. Each merged region can include multiple regions, such as 2, 3, 4, or 5 regions, each corresponding to a face of the platonic solid. Each merged region can have a shape of a parallelogram, a trapezoid, and the like.

At S1830, one or more merged or connected regions can be translated or moved vertically or horizontally to fill one or more blank areas among the regions in order to obtain a rectangular compact image. Or, in other words, one or more merged or connected regions can be translated or moved to combine with the rest of the regions in order to form the rectangular compact image. In some examples, in addition to moving merged or connected regions, part of the regions is also moved in order to form the rectangular compact image.

At S1840, a region can be split into sub-regions.

At S1850, in order to obtain the rectangular compact image, a part of the sub-regions can be translated or moved to fill blank areas which cannot contain a whole region. As a result, the rectangular compact image can be obtained. The resultant rectangular compact image can include no blank areas. The process proceeds to S1899 and terminates at S1899.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving a two-dimensional (2D) projected image generated by projecting a spherical image of an omnidirectional video onto faces of a platonic solid, the 2D projected image having regions each corresponding to a face of the platonic solid; and
rearranging the regions to form a compact image, wherein at least two nonadjacent regions in the 2D projected image corresponding to two faces that are adjacent to each other along a first edge on the platonic solid are arranged to be adjacent to each other along the same first edge in the compact image to maintain continuity between the two nonadjacent regions.

2. The method of claim 1, wherein the compact image has a rectangular shape.

3. The method of claim 1, wherein rearranging the regions include:
rearranging the regions in a manner such that a number of discontinuous boundaries in the compact image is less than a number of discontinuous boundaries in the 2D projected image.

4. The method of claim 1, wherein rearranging the regions include:
rotating a first region of the two nonadjacent regions, such that the rotated first region is connected with a second region of the two nonadjacent regions along the first edge.

5. The method of claim 4, wherein rearranging the regions further include:
rotating a third region, such that the rotated third region is connected with the second region along a second edge to form a connected region including the first, second and third regions, wherein two faces on the platonic solid corresponding to the second and third regions are adjacent to each other along the same second edge.

6. The method of claim 1, wherein rearranging the regions include:
adjusting the two nonadjacent regions along the same first edge to form a connected region; and
moving the connected region to fill a blank area in the 2D projected image.

7. The method of claim 1, wherein the platonic solid is one of an octahedron or an icosahedron.

8. A video system, comprising circuitry configured to:
receive a two-dimensional (2D) projected image generated by projecting a spherical image of an omnidirectional video onto faces of a platonic solid, the 2D projected image having regions each corresponding to a face of the platonic solid; and
rearrange the regions to form a compact image, wherein at least two nonadjacent regions in the 2D projected image corresponding to two faces that are adjacent to each other along a first edge on the platonic solid are arranged to be adjacent to each other along the same first edge in the compact image to maintain continuity between the two nonadjacent regions.

9. The video system of claim 8, wherein the compact image has a rectangular shape.

10. The video system of claim 8, wherein the circuitry is configured to:
rearrange the regions in a manner such that a number of discontinuous boundaries in the compact image is less than a number of discontinuous boundaries in the 2D projected image.

11. The video system of claim 8, wherein the circuitry is configured to:
rotate a first region of the two nonadjacent regions, such that the rotated first region is connected with a second region of the two nonadjacent regions along the first edge.

12. The video system of claim 11, wherein the circuitry is further configured to:
rotate a third region, such that the rotated third region is connected with the second region along a second edge to form a connected region including the first, second and third regions, wherein two faces on the platonic solid corresponding to the second and third regions are adjacent to each other along the same second edge.

13. The video system of claim 8, wherein the circuitry is configured to:
adjust the two nonadjacent regions along the same first edge to form a connected region; and
move the connected region to fill a blank area in the 2D projected image.

14. The video system of claim 8, wherein the platonic solid is one of an octahedron or an icosahedron.
